(19) United States
(12) Patent Application Publication
(10) Pub. No.: US 2025/0227022 A1
(43) Pub. Date: Jul. 10, 2025

(54) Interface System for Processing and Controlling the Data Flow Between a Cloud and a Technical System

(71) Applicant: TTTech Computertechnik Aktiengesellschaft, Vienna (AT)

(72) Inventor: Hermann KOPETZ, Baden Siegenfeld (AT)

(21) Appl. No.: 19/004,822

(22) Filed: Dec. 30, 2024

(30) Foreign Application Priority Data
Jan. 10, 2024 (EP) 24151146.8

(51) Int. Cl. H04L 41/0677; H04L 67/10

(52) U.S. Cl. CPC H04L 41/0677; H04L 67/10

(57) ABSTRACT

The invention relates to an interface system, which is arranged between a technical system and the cloud and which prevents malware originating from the cloud or errors in the data delivered by the cloud from causing essential functions of the technical system to fail. The interface system comprises two fault containment units (FCUs), FCU_1 and FCU_2, and a restrictive data connection between these two FCUs. Using this restrictive data connection, a well-defined periodic data flow is realized between the two FCUs. The stringent restrictions in the data flow from FCU_2 to FCU_1 make it technically impossible for an intruder to transmit malware from FCU_2 to FCU_1 even if they have assumed complete control over FCU_2. This provides protection of the FCU_1 and, therefore, the technical system from attacks from the cloud.

### CROSS-REFERENCE TO RELATED APPLICATIONS

This application claims priority to and the benefit of European Patent Application No. EP 24151146.8, filed Jan. 10, 2024, which is hereby incorporated by reference herein in its entirety.

### FIELD

The invention relates to an interface system for processing and controlling a data flow between a cloud and a technical system or the data flow from the cloud to the technical system, wherein the interface system comprises two fault containment units, FCUs, FCU_1 and FCU_2, wherein the interface system can be connected to the technical system via an external interface of FCU_1, and wherein the interface system can be connected to the cloud via an external interface of FCU_2.

### BACKGROUND

In some technical applications, a distinction can be made between stand-alone operation and optimized operation of a technical system.

For example, in a photovoltaic system, the energy supplied by the PV panels is managed in stand-alone operation according to a fixed plan. First of all, the local consumers are supplied, then the battery is charged and finally, the remaining energy is supplied to the electrical grid. In optimized operation, complex optimization algorithms use weather data from the internet, planned consumption data and staggered energy prices expected by the market to calculate when energy should be supplied to the grid and when the energy should be stored in the battery in order to generate an optimum financial return.

The complex optimization algorithms which calculate the optimum setpoint values for operation of the technical system can be executed in the cloud.

### SUMMARY

It is an object of the invention to prevent malware from entering the technical system from the cloud.

This object is achieved with an aforementioned interface system in that, according to the invention, the interface system comprises two fault containment units, FCUs, FCU_1 and FCU_2, wherein the interface system can be connected to the technical system via an external interface of FCU_1, and wherein the interface system can be connected to the cloud via an external interface of FUC_2, and wherein FCU_1 and FCU_2 are connected via a communication channel, through which a data flow of data can be transmitted from FCU_2 to FCU_1, and wherein FCU_1 is configured such that it cannot write any data that is transmitted from FCU_2 to FCU_1 via this communication channel to its command registers. An FCU comprises a command register which contains all commands that the FCU (or the one or more CPUs of the FCU) can execute. Due to the special configuration of FCU_1, for example realized in the software, FCU_1 cannot write data that is transferred from FCU_2 to FCU_1 to its command registers. This prevents malware from FCU_2 or from the cloud from being executed on FCU_1. Thus, there is a restrictive data connection between the two FCUs in the direction from FCU_2 to FCU_1 via the communication channels, wherein FCU_2 can only transmit data to FCU_1 via this communication channel.

The invention thus relates to an interface system, which is arranged between a technical system and the cloud and which prevents malware originating from the cloud from causing essential functions of the technical system to fail.

Thanks to the invention, it is, in particular, not necessary for malware detection programs to be run on FCU_1.

Advantageous embodiments of the invention are described in the dependent claims.

It is advantageous if the data flow from FCU_2 to FCU_1 is realized exclusively by means of a sequence of periodic message instances, the so-called FCU_2 message instances, which are sent from FCU_2 to FCU_1, wherein each message instance in this sequence of message instances has the same format, which format is preferably determined a priori, and wherein FCU_1 verifies whether
an FCU_2 message instance arrives at FCU_1 in each period, and
whether every value contained in a data field of an incoming FCU_2 message instance falls within a value range, which is associated with this data field in FCU_1, and wherein
   in the event that
      an FCU_2 message instance does not arrive at FCU_1,
      the verification of an incoming FCU_2 message instance by FCU_1 detects an error in a received FCU_2 message instance,
   the erroneous FCU_2 message instance is discarded and a program available in FCU_1 is activated to realize a stand-alone operation of the technical system.

This achieves a restrictive data flow from FCU_2 to FCU_1.

This allows to prevent that an error occurring in the optimum setpoint values as calculated by the cloud, or an error in the data supplied by the cloud or by FCU_2, causes the technical system to malfunction or fail.

The term “FCU_2 message instance” denotes a message instance sent by FCU_2.

It may be provided that FCU_1 is a sub-system of the technical system.

It may be provided that FCU_1 and FCU_2 are realized in one unit. In this case, the interface system forms an interface computer.

It may further be provided that successful receipt of a file sent by FCU_1 to FCU_2 is acknowledged by FCU_2 in a periodic FCU_2 message instance following receipt of the sent file.

It may advantageously be provided that both FCUs have a global time and the periodic sequence of message instances is sent from FCU_2 to FCU_1 in a time-controlled manner.

In particular, it may be provided that both FCUs have access to a global time signal (e.g. GPS or DCF77).

By way of example, it may be provided that FCU_1 and FCU_2 each have an independent power supply.

It may be provided that the communication channel is realized between an internal interface of FCU_1 and an internal interface of FCU_2, wherein the communication channel is preferably a secure wireless channel.

The data flow from FCU_2 to FCU_1 may preferably be transmitted via these internal interfaces or the wireless channel and further communication takes place from FCU_1 to FCU_2 and vice versa.

The term “internal” does not refer to an internal arrangement, but rather to the fact that the communication that is taking place via these (internal) interfaces or the connection realized by using them is internal to the interface. Likewise, the term “external” interface does not relate to an external arrangement of the interface, but rather communication with or a connection to a device/installation that is external to the interface system.

It may further be provided that the communication between the external interface of FCU_1 and the technical system is carried out via a secure wireless channel.

In addition, it may be provided that in FCU_1 a memory is provided, in which data of the technical system, in particular recorded data of the technical system can be stored.

It may be provided that FCU_1 has an unrestricted connection to the internet, which can be interrupted by means of a mechanical switch.

In summary, it is proposed according to the invention to install an interface computer between the technical system and the cloud which prevents malware from the cloud from entering the technical system, and/or which activates the non-optimum stand-alone operation of the technical system after detection of an error in the setpoint values supplied by the cloud. According to the invention, the interface system comprises two fault containment units, FCUs, a first FCU_1 and a second FCU_2, and a restrictive data connection between these two FCUs.

A fault containment unit (FCU) is a self-contained sub-system of a distributed computer system that isolates the immediate effects of a fault on the affected sub-system, i.e. on the FCU itself, regardless of whether the cause of the fault lies in the hardware, the software, or an intrusion, and where the entire sub-system exhibits a defined fault behaviour, such as a complete failure, in the event of a fault. The design must ensure that failures of FCUs occur independently of each other. Different FCUs should run different software on separate hardware and preferably have a separate power supply.

Each of the two FCUs of the interface system has at least one external interface and at least one internal interface.

The at least one external interface of FCU_1 establishes the connection(s) to the technical system and addresses the given interface requirements of the technical system. The at least one internal interface of FCU_1 is connected to an internal interface of FCU_2. The restrictive data flow is achieved between the two FCUs via these internal interfaces. The at least one external interface of FCU_2 is connected to the cloud.

The functions of FCU_1 can also be transferred to a sub-system of the technical system. In this case, this sub-system of the technical system forms FCU_1. The restrictive data flow then takes place between this sub-system of the technical system and FCU_2.

The data flow from FCU_1 to FCU_2 is not restricted. A file transfer from FCU_1 to FCU_2 can be acknowledged by an acknowledgement signal, which is sent in one of the periodic messages from FCU_2 to FCU_1 after the files have been successfully received by FCU_2. The stringent restrictions in the data flow from FCU_2 to FCU_1 make it technically impossible for an intruder to transmit malware from FCU_2 to FCU_1 even if they have assumed complete control over FCU_2. This protects FCU_1 and therefore the technical system from attacks from the cloud.

The communication between the internal interface of FCU_1 and the internal interface of FCU_2 can be handled via a wired or via a secure wireless communication channel.

The invention further relates to a technical system which is connected, or can be connected, to a cloud by a described interface system.

For example, in such a technical system, FCU_1 is a sub-system of the technical system.

The invention also relates to a system of equipment comprising a technical system that is connected to a described interface system, and using which a connection to the cloud can be realized.

### EXPLANATION OF TERMS USED

The notional meaning of important terms used in the description is set out below.
Cloud: The term cloud is understood as relating to a number of remote computers that can be accessed via a secure internet connection.
Fault containment unit: A fault containment unit (FCU) is a self-contained sub-system of a distributed computer system that isolates the immediate effects of a fault on the affected sub-system (i.e. on the FCU), regardless of whether the cause of the fault lies in the hardware, the software or an intrusion, and where the entire sub-system exhibits a defined fault behaviour, such as a complete failure, in the event of a fault.
Global time signal: An external signal that specifies the global time (e.g. GPS or DCF-77).
Interface computer: A computer that handles the connection, data customisation and control of the data flow between a technical system and the cloud.
Interface system: A system that handles the connection, data customisation and control of the data flow between a technical system and the cloud.
Intruder: A third-party infiltrator of a computer system.
Intrusion: An intrusion (e.g. successful hacker attack) into a computer system.
Actual data: Actual values which describe the current state of the technical system in a period.
Malware: Software (such as viruses, worms, etc.) that infiltrates computer systems and can cause faults or damage to them.
Optimization system: A system that specifies the setpoint values for the optimum operation of a technical system, taking given external conditions (e.g. dynamic market conditions) into account.
PAR protocol: A PAR protocol (Positive Acknowledgement with Retransmission) is a method used in data transmission to identify and prevent the loss of data during transmission.
Restrictive data flow: A periodic sequence of message instances with identical format, where the permitted value ranges of the data fields are verified in each instance of the message by the recipient of the message and where, in the event of an error, the erroneous instance of the message is discarded by the recipient.
Restrictive data connection: A data connection between a sender and a recipient, wherein the recipient cannot write data that it receives via this data connection to its command registers.
Setpoint data: Setpoint values for a technical system in a specified period.
Stand-alone operation: An operating state during which the technical system is operated without consideration of external conditions (e.g. dynamic market conditions).
Technical system: All of the local sub-systems involved in solving a technical task. For example, the following possible sub-systems are involved in the energy management system technical system: the PV system, the inverter, a battery, a wall box, a heat pump and other local energy consumers.

### BRIEF DESCRIPTION OF THE DRAWINGS

The invention is explained in more detail below based on a non-limiting example. In the figures

FIG. 1 shows an example of a structure of an interface computer according to an embodiment of the invention and the connection of the interface computer to a cloud as well as to a technical system, and

FIG. 2 shows the format of the messages transmitted from FCU_2 to FCU_1 according to one embodiment.

### DETAILED DESCRIPTION

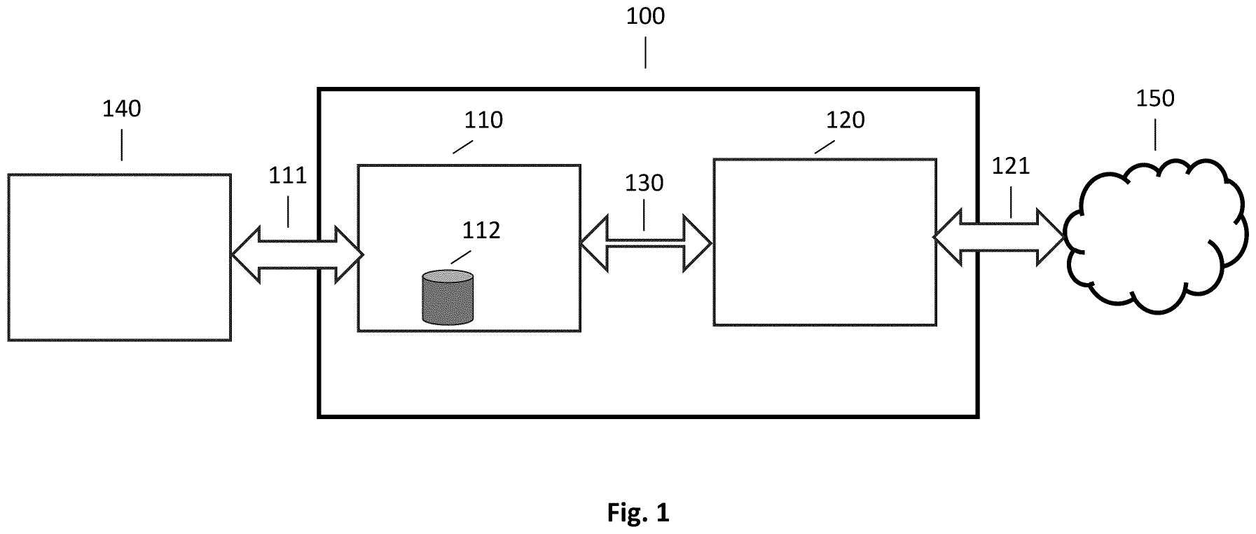

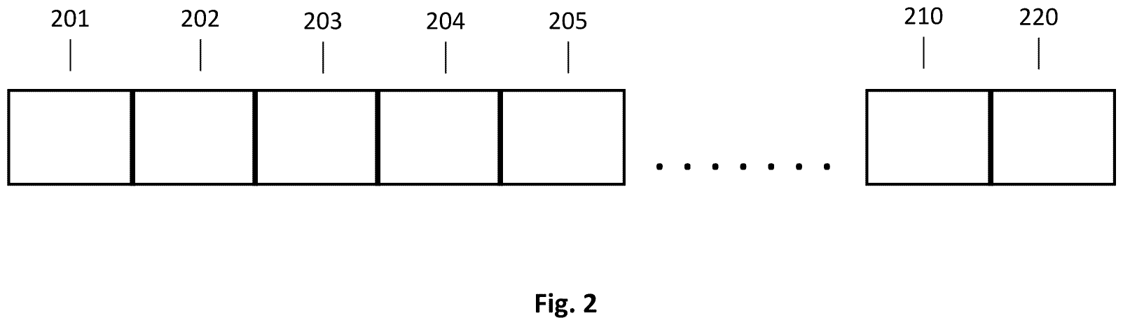

One of many possible embodiments of the invention is explained below in detail based on FIG. 1 and FIG. 2.

FIG. 1 shows a possible structure of an interface system, wherein, in this example, the interface system is designed as an interface computer 100. The interface computer 100 comprises two fault containment units (FCUs), FCU_1 110 and FCU_2 120.

FCU_1 comprises an external interface, via which a communication channel 111 to a technical system 140 is implemented.

FCU_2 comprises an external interface, via which a communication channel 121 to a cloud 150 is implemented.

FCU_1 110 and FCU_2 120 each comprise an internal interface, via which a data connection 130 between the two FCUs is implemented. The communication via the, in particular restrictive, data connection 130 between the internal interface of FCU_1 110 and the internal interface of FCU_2 120 can be handled via a wired connection or via a secure wireless channel.

The term “external” emphasizes that it is an interface with which a connection can be established to a device that is external to the interface computer or system. The term “external” does not, however, mean that the interface is external to its FCU.

Each of the two FCUs, FCU_1 110 and FCU_2 120, constitutes a complete computer with hardware independent of the other computer, its own, preferably diverse, software and preferably its own energy supply. FCU_1 110 is connected to the technical system 140, in particular to one or more sub-systems of the technical system 140, via the communication channel 111. FCU_2 120 is connected to the cloud via the communication channel 121. The communication channels 111 and 121 can exchange data via a wired medium or wirelessly using secure protocols.

It is advantageous if FCU_1 110 and FCU_2 120 have access to a global time. The global time can be taken from an external time signal, e.g. GPS or DCF77.

The technical system 140 comprises all the sub-systems involved in the solution of a technical task at the site of the technical system. For example, a PV system, inverter, battery, wallbox, heat pump and other local energy consumers are sub-systems involved in an energy management system technical system. Each individual one of these sub-systems can preferably be addressed via the communication channel 111 to the technical system 140. FCU_1 110 and FCU_2 120 are connected via a communication channel 130, via which a data flow, in particular the entire data flow of the data transmitted from FCU_2 120 to FCU_1 110 flows. FCU_1 110 is configured in such a way that it cannot write any data that is transmitted from FCU_2 120 to FCU_1 110 via this communication channel 130 to its command registers.

If malware is therefore transported via the communication channel 130 from FCU_2 to FCU_1, it cannot be executed on FCU_1, as FCU_1 does not write any data it receives from FCU_2 to its command registers.

A restrictive data flow is also implemented between FCU_2 120 and FCU_1 110, which consists of a periodic, preferably time-controlled, sequence of message instances of an identical message format, as explained in more detail based on FIG. 2 and also with reference to the introduction. The communication via the communication channel 130 between FCU_2 120 and FCU_1 110 is therefore so restrictive that no malware can be transported via this communication channel 130.

A data memory 112 is preferably contained in FCU_1 110 in which the setpoint data and the actual data of the technical system 140 can be stored, preferably in every period with a timestamp identifying the period, so that if communication with the cloud fails, no operating data is lost.

FCU_1 110 can also be embodied by a sub-system of the technical system 140. In this case, the restrictive data flow takes place between FCU_2 120 and this sub-system of the technical system 140.

FIG. 2 shows a possible constant message format by way of example. All message instances sent from FCU_2 120 to FCU_1 110 must correspond to such a constant message format, as shown by way of example in FIG. 2. The first field 201 of a message instance contains the send timestamp of the message instance, which can also be used to identify the message instance. This timestamp generated by FCU_2 120 must be in a time interval that FCU_1 110 can check with reference to the temporal distance to the previous periodic message instance. The field 202 contains an error code or an action code, which must correspond to an element from the list of defined codes. The field 203 is a parameter code, the value range of which depends on the code contained in the field 202.

The fields 202 and 203 can be used to implement a PAR (Positive Acknowledgement with Retransmission) protocol of a file transfer from FCU_1 110 to FCU_2 120. After the successful receipt of a file sent from FCU_1 110 to FCU_2 120, FCU_2 120 includes the Positive Acknowledgement Code contained in a list of defined codes in the field 202 and the file name (e.g. send timestamp of the file sent by FCU_1) in the field 203 in the next periodic message from FCU_2 to FCU_1. The successful receipt of the file sent by FCU_1 110 is thus acknowledged by FCU_2 120. If an acknowledgement of the sent file has not arrived at FCU_1 110 after a predetermined time interval, the procedure for sending the file is repeated by FCU_1 110.

The fields 204 to 210 contain setpoint values for the sub-systems of the technical system 140. Each of these setpoint values must fall within a value range which FCU_1 110 specifies or which is specified for FUC_1 110 on the basis of the current state of the technical system 100. The setpoint values are provided by the cloud 150.

The last field 210 contains a CRC code in order to be able to check the syntactic integrity of a message instance.

If an expected message instance from FCU_2 to FCU_1 110 fails or if a data field of a message instance of FCU_2 120 contains a value that falls outside of the value range considered valid by FCU_1 110 at this time, FCU_1 110 discards the erroneous message instance and activates the stand-alone operation of the technical system 140.

FCU_1 100 can preferably establish an unrestricted, additional connection to the internet, independent of FCU_2, to load new software into FCU_1 110. This connection can preferably be interrupted by a mechanical switch after the loading process has been successfully completed. The integrity of the core image of FCU_1 must then be checked to ensure that FCU_1 does not contain any malware. In normal operation, there must be no direct connection from FCU_1 110 to the internet.

1. An interface system (100) for processing and controlling a data flow between a cloud (150) and a technical system (140) or the data flow from the cloud (150) to the technical system (140), wherein the interface system (100) comprises:
two fault containment units, FCUs, FCU_1 (110) and FCU_2 (120), wherein
the interface system (100) is connectable to the technical system (140) via an external interface of FCU_1 (110),
the interface system (100) is connectable to the cloud (150) via an external interface of FCU_2 (120),
FCU_1 (110) and FCU_2 (120) are connected via a communication channel (130), via which a data flow of data can be transmitted from FCU_2 (120) to FCU_1 (110), and
FCU_1 (110) is configured such that it cannot write any data that is transmitted from FCU_2 (120) to FCU_1 (110) via said communication channel (130) to its command registers.

2. The interface system according to claim 1, wherein the data flow from FCU_2 (120) to FCU_1 (110) is realized exclusively by means of a sequence of periodic message instances, the so-called FCU_2 message instances, which are sent from FCU_2 to FCU_1, wherein each message instance in said sequence of message instances has the same format, and
wherein FCU_1 (110) verifies whether
in each period an FCU_2 message instance arrives at FCU_1, and
whether every value contained in a data field of an incoming FCU_2 message instance falls within a value range associated with said data field in FCU_1, and
wherein
in the event that
an FCU_2 message instance does not arrive at FCU_1,
the verification of an incoming FCU_2 message instance by FCU_1 detects an error in a received FCU_2 message instance,
the erroneous FCU_2 message instance is discarded and a program present in FCU_1 for implementing stand-alone operation of the technical system is activated.

3. The interface system according to claim 1, wherein FCU_1 is a sub-system of the technical system.

4. The interface system according to claim 1, wherein FCU_1 and FCU_2 are implemented in one unit.

5. The interface system according to claim 1, wherein successful receiving of a file sent by FCU_1 to FCU_2 is acknowledged by FCU_2 in a periodic FCU_2 message instance following receipt of the sent file.

6. The interface system according to claim 1, wherein both FCUs (110, 120) have a global time and the periodic sequence of message instances is sent from FCU_2 (120) to FCU_1 (110) in a time-controlled manner.

7. The interface system according to claim 1, wherein both FCUs (110, 120) have access to a global time signal (e.g. GPS or DCF77).

8. The interface system according to claim 1, wherein FCU_1 (110) and FCU_2 (120) each have an independent power supply.

9. The interface system according to claim 1, wherein the communication channel (130) is realized between an internal interface of FCU_1 (110) and an internal interface of FCU_2 (120).

10. The interface system according to claim 1, wherein the communication between the external interface of FCU_1 (110) and the technical system (140) is carried out via a secure wireless channel (111).

11. The interface system according to claim 1, wherein in FCU_1 (110) a memory (112) is provided, in which data of the technical system (140) can be stored, in particular recorded data of the technical system.

12. The interface system according to claim 1, wherein FCU_1 (110) has an unrestricted connection to the internet, which can be interrupted by means of a mechanical switch.

13. A technical system which is connected to a cloud (150) using an interface system according to claim 1.

14. A system according to claim 13, wherein FCU_1 (110) is a sub-system of the technical system.

15. A system of equipment comprising a technical system (140) connected to an interface system (100) according to claim 1.

16. The interface system according to claim 2, wherein the format of said sequence of message instances has been determined a priori.

17. The interface system according to claim 9, wherein the communication channel (130) is a secure wireless channel.
